(19) United States
(12) Patent Application Publication
(10) Pub. No.: US 2016/0082402 A1
(43) Pub. Date: Mar. 24, 2016

(54) METHOD OF PRODUCING DISPERSION AND APPARATUS FOR PRODUCING DISPERSION

(71) Applicant: Seiko Epson Corporation, Tokyo (JP)

(72) Inventors: Kenji KITADA, Shiojiri (JP); Maki NARIAI, Shiojiri (JP); Atsushi DENDA, Chino (JP); Naoyuki TOYODA, Suwa (JP)

(21) Appl. No.: 14/859,717

(22) Filed: Sep. 21, 2015

(30) Foreign Application Priority Data
Sep. 22, 2014 (JP) 2014-192137
Feb. 27, 2015 (JP) 2015-038290

(51) Int. Cl. B01F 11/02; B02C 19/18; B01F 3/12

(52) U.S. Cl. CPC B01F 11/02; B01F 3/1242; B01F 3/1207; B02C 19/18

(57) ABSTRACT

A method of producing a dispersion according to the invention includes preparing a mixed liquid containing a dispersoid and a dispersion medium, and dispersing the dispersoid in the dispersion medium by subjecting the dispersoid in the mixed liquid to an in-liquid plasma processing while subjecting the dispersoid to a pulverization processing.

### BACKGROUND

1. Technical Field

The present invention relates to a method of producing a dispersion and an apparatus for producing a dispersion.

2. Related Art

In recent years, research into modifying the surface state of a substance using plasma has been actively performed. Modifying a surface by ionized molecules (for example, a hydroxy group) of plasma through irradiating a target substance with plasma, thereby improving the wettability by water is known.

A liquid surface plasma technique in which plasma is generated in the vicinity of a liquid surface is known as such a technique using plasma (for example, refer to JP-A-2013-34914). JP-A-2013-34914 discloses a technique that achieves an improvement in the dispersion effect of a dispersoid by using both a liquid surface plasma processing in which one of a pair of electrodes is immersed in a liquid or is brought in contact with the liquid surface and the other is arranged in the air at the upper portion of the liquid surface, and a voltage is applied between the electrodes, thereby generating plasma, and a mechanical dispersion processing (processing for stirring while sheering the particles).

However, in the technology disclosed in JPA-2013-34914, even if a new interface is formed when the dispersoid is crushed in a liquid by a mechanical dispersion process, it is possible to carry out the plasma processing only at the liquid surface. Therefore, a problem arises where it is difficult to obtain a synergistic effect between the mechanical dispersion process and the plasma process, and the processing efficiency is poor.

Since the plasma processing is executed only at the liquid surface, although an effect due to the plasma processing is easily obtained, in a case of a dispersoid with a low specific gravity relative to the dispersion medium, an effect due to the plasma processing is not easily obtained in a case of a dispersoid with a high specific gravity relative to the dispersion medium.

### SUMMARY

An advantage of some aspects of the invention is to provide a method of producing a dispersion and an apparatus for producing a dispersion able to efficiently disperse a dispersoid in a dispersion, and with which a dispersion with excellent dispersion stability is obtained.

The invention can be realized in the following forms or application examples.

### Application Example 1

According to an aspect of the invention, there is provided a method of producing a dispersion, including preparing a mixed liquid containing a dispersoid and a dispersion medium; and dispersing the dispersoid in the dispersion medium by subjecting the dispersoid in the mixed liquid to an in-liquid plasma processing while subjecting the dispersoid to a pulverization processing.

According to the method of producing a dispersion of Application Example 1, because the pulverization processing of the dispersoid and the plasma processing are carried out at approximately the same time in the liquid, the plasma processing can be carried out before the pulverized dispersoid re-aggregates or the like. The generation of plasma can be promoted using air bubbles created by cavitation being generated by the pulverization processing process. Thus, efficiency of the dispersion process of the dispersoid in the dispersion medium is improved. Re-aggregation, precipitation and the like of the dispersoid after the dispersoid is dispersed can be prevented over the long term, thereby improving the dispersion stability.

### Application Example 2

In the method of producing a dispersion of Application Example 1, the dispersoid may be a solid.

According to the method of producing a dispersion of Application Example 2, since the interface of the dispersoid subjected to the pulverization processing does not have fluidity as in a fluid, due to the dispersoid being a solid, the effects due to the plasma processing is easily obtained. Therefore, the efficiency of the dispersion process and the dispersion stability are further improved.

### Application Example 3

In the method of producing a dispersion of Application Example 1 or 2, the unit that carries out the pulverization processing may be a unit that generates cavitation along with the pulverization.

In the method of producing a dispersion of Application Example 3, cavitation is generated by the pulverization processing, and plasma can be generated in the air bubbles created by the cavitation. In so doing, since the efficiency of the plasma generation is increased, the efficiency of the dispersion process is improved.

### Application Example 4

In the method of producing a dispersion of Application Example 1 or 2, the unit that carries out the pulverization processing may be an ultrasound generation apparatus, and the frequency of the ultrasound generating apparatus may be 20 kHz or more and 1000 kHz or less.

According to the method of producing a dispersion of Application Example 4, since not only can the dispersoid be refined by the pulverization processing using ultrasound, but plasma can also be generated in the air bubbles created by the cavitation generated by the ultrasound, the efficiency of plasma generation is increased, and the efficiency of the dispersion process is improved as a result.

### Application Example 5

In the method of producing a dispersion of any one of Application Examples 1 to 4, a concentration of the dispersoid in the mixed liquid may be 0.1 mass % or more and less than 70 mass %.

According to the method of producing a dispersion of Application Example 5, an increase in the collision frequency of the dispersoid subjected to the pulverization processing can be suppressed, and a dispersion with a high dispersion stability in which re-aggregation and the like of the dispersoid does not easily occur can be produced.

### Application Example 6

In the method of producing a dispersion of any one of Application Examples 1 to 5, a primary particle size of the dispersoid may be less than 1000 nm.

According to the method of producing a dispersion of Application Example 5, since the dispersoid can be produced at a size of less than 1000 nm that is the primary particle size through the pulverization processing, the risk of precipitation or the like is lowered, and the dispersion stability is further improved.

### Application Example 7

According to another aspect of the invention, there is provided an apparatus for producing a dispersion, including a storage tank in which a mixed liquid containing a dispersoid and a dispersion medium is introduced; a pulverization processing mechanism that pulverizes the dispersoid in the mixed liquid introduced in the storage tank; and an in-liquid plasma processing mechanism that subjects the dispersoid in the mixed liquid introduced in the storage tank to plasma processing, in which the dispersoid is dispersed in the dispersion medium by subjecting the dispersoid in the mixed liquid to in-liquid plasma processing with the in-liquid plasma processing mechanism while subjecting the dispersoid to pulverization process with the pulverization processing mechanism.

According to the apparatus for producing a dispersion of Application Example 7, because the pulverization processing of the dispersoid and the plasma processing are carried out at approximately the same time in the liquid, the plasma processing can be carried out before the pulverized dispersoid re-aggregates or the like. It is possible for the generation of plasma to be promoted using air bubbles created by cavitation being generated by the pulverization processing mechanism. Thus, efficiency of the dispersion process of the dispersoid in the dispersion medium is improved. Re-aggregation, precipitation, and the like of the dispersoid after processing can be prevented over the long term, and a dispersion with excellent dispersion stability can be produced.

### BRIEF DESCRIPTION OF THE DRAWINGS

The invention will be described with reference to the accompanying drawings, wherein like numbers reference like elements.

FIG. 1 is a schematic view of an apparatus for producing a dispersion according to a first embodiment.

FIG. 2 is a schematic view of an apparatus for producing a dispersion according to a second embodiment.

### DESCRIPTION OF EXEMPLARY EMBODIMENTS

Below, favorable embodiments of the invention will be described. The embodiments described below are for describing an example of the invention. Further, the invention is not limited by the below embodiments and includes various types of modifications carried out in a scope not departing from the gist of the invention. Not all of the configurations explained below are indispensable configurations in the invention.

The wording “in-liquid plasma” in the invention indicates an in-liquid non-equilibrium low temperature plasma, and, more specifically, refers to plasma generated in air bubbles while applying a voltage to both electrodes immersed in a dispersion medium while forming air bubbles in the dispersion medium in a state where both of a pair of electrodes are immersed in the dispersion medium or in contact with the liquid surface of the dispersion medium.

Below, the apparatus for producing a dispersion, method of producing a dispersion, and the dispersion produced by the method of production according to the embodiment are described in that order.

### 1. Apparatus for Producing a Dispersion

The apparatus for producing a dispersion according to the embodiment includes a storage tank in which a mixed liquid containing a dispersoid and a dispersion medium is introduced; a pulverization processing mechanism that pulverizes the dispersoid in the mixed liquid introduced in the storage tank; and an in-liquid plasma processing mechanism that subjects the dispersoid in the mixed liquid introduced in the storage tank to plasma processing. Below, the apparatus for producing a dispersion according to the embodiment is described with reference to the drawings.

### 1.1. Apparatus Configuration of First Embodiment

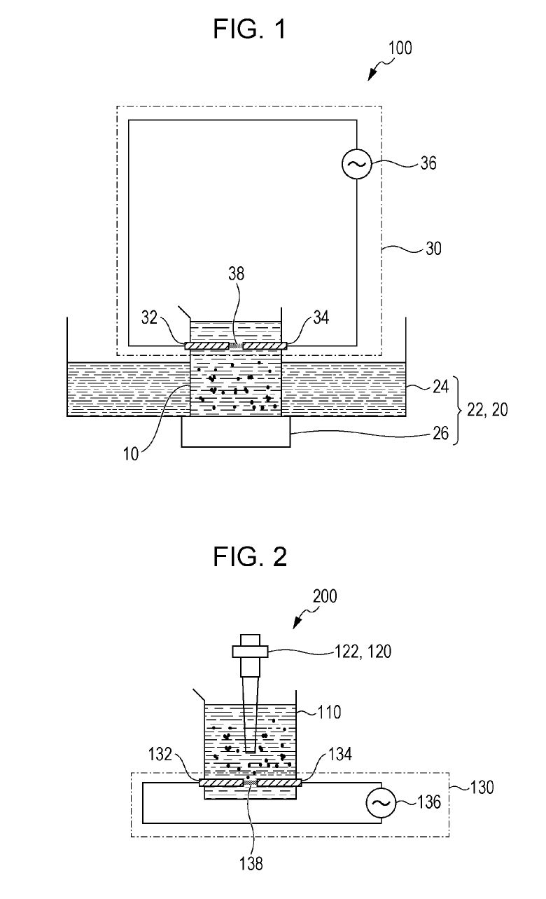

FIG. 1 is a schematic view of an apparatus for producing a dispersion according to the first embodiment. The production apparatus 100 includes a storage tank 10 in which a mixed liquid containing a dispersoid and a dispersion medium is introduced; a pulverization processing mechanism 20 for pulverizing the dispersoid in the mixed liquid introduced in the storage tank 10; and an in-liquid plasma processing mechanism 30 that subjects the dispersoid in the mixed liquid introduced in the storage tank 10 to plasma processing.

Although the material of the storage tank 10 is not particularly limited as long as the tank is able to hold the mixed liquid before and after plasma generation, examples may include materials such as glass, resin, and metal. When a material having transparency to visible light, such as glass or resin, is selected as the material of the storage tank 10, it is possible to observe the dispersion state from outside the storage tank 10, and thus is preferable. Examples of the material having transparency include glass, polyethylene terephthalate resins, polyvinyl chloride resins, acrylic resins, and polycarbonate. The shape of the storage tank 10 is not particularly limited as long as the electrodes 32 and 34 of the in-liquid plasma processing mechanism 30 are able to be inserted in the interior of the storage tank 10, and the shape is able to be fixed. The storage tank 10 is arranged so as to be immersed in water introduced in a cleaning tank 24 of an ultrasound cleaning device 22, described later.

In the first embodiment, the pulverization processing mechanism 20 is configured by the ultrasound cleaning device 22. The ultrasound cleaning device 22 is provided with a cleaning tank 24 and an ultrasound generator 26. In the example shown in FIG. 1, although the ultrasound generator 26 is attached only to the outside of the bottom surface of the cleaning tank 24, there is no limitation to such a configuration, and the ultrasound generator 26 may be attached to the outside of the side surface of the cleaning tank 24. A configuration may be used in which an ultrasound oscillator, such as a disk-type oscillator or a spherical surface-type oscillator, is placed in direct contact with the inside of the cleaning tank 24 or the inside of the storage tank 10. It is possible for the even the primary particles of the dispersoid to be finely dispersed by the cavitation occurring due to the ultrasound cleaning device 22. It is necessary to introduce the water necessary for the generation of cavitation to the cleaning tank 24.

The energy amount necessary for the generation of cavitation in ordinary water varies according to the frequency. That is, although it is possible for cavitation to be generated at a lower energy amount as the frequency decreases, because the energy amount is influenced by the amplitude and the frequency, when the frequency is excessively low, amplification by the same amount is necessary. Therefore, when the balance between the amount of generated cavitation and the energy amount necessary therefor is considered, it is preferable that the frequency is 20 kHz to 1000 kHz, and 20 kHz to 500 kHz is more preferable. In the ultrasound cleaning device 22, the oscillation frequency and the phase of the oscillator (not shown) in the ultrasound generator 26 may each be independently adjusted by adjusting the parameters of a circuit element such as a resistor, capacitor, or coil that configures an oscillation circuit.

It is possible to use an ultrasound cleaning device such as models “W-113”, “W-357-07HPD”, or “W-357 HPD” manufactured by Honda Electronics Co., Ltd., and the Bransonic series manufactured by Branson Ultrasonics Corp.

The in-liquid plasma processing mechanism 30 is configured by a pair of electrodes 32 and 34 arranged in a state of being immersed in the mixed liquid or in contact with the liquid surface of the mixed liquid introduced in the storage tank 10, and a power source 36. Although not shown in the drawings, a gas storage unit and gas introduction pipe may be provided for introducing gas to the plasma generator 38 between the electrodes 32 and 34.

Although examples of the shape of the tip end of the electrodes 32 and 34 include a needle-like, hollow needle-like, cylindrical, spherical, half-spherical, linear, and plate-like, the shape is preferably needle-like by which plasma is easily generated even at low voltages. The tip end of the electrodes 32 and 34 are not necessarily even, and steps may arise to an extent at which in-liquid plasma may be generated.

Although the material of the electrodes 32 and 34 is not particularly limited as long as the material has conductivity, examples thereof include copper, tungsten, a copper-tungsten alloy, graphite, titanium, stainless, molybdenum, aluminum, iron, nickel, platinum, and gold.

The power source 36 used in generation of the in-liquid plasma may use methods such as a direct current power source, a pulse power source, a low frequency-high frequency alternating current power source, and a microwave power source. Among these, it is preferable to use a power source capable of output at an alternating current frequency of 30 kHz or less in order for plasma to be generated at low temperatures and stably.

The generation mechanism of the in-liquid plasma in the in-liquid plasma processing mechanism 30 is as follows. In the plasma generator 38, when a pulse voltage is applied between the electrodes 32 and 34, localized joule heating is generated due to the pulse voltage application, the dispersion medium or dissolved oxygen at the electrodes 32 and 34 is vaporized, and air bubbles of a micrometer or less are generated in the mixed liquid. When the space between the electrodes 32 and 34 is filled with air bubbles with a fixed density, insulation breakdowns occur, and plasma is generated in the air bubbles. The current rapidly increases accompanying the generation of the plasma, and the voltage is lowered so as to maintain the power.

In the production apparatus 100 according to the first embodiment, cavitation is generated by the ultrasound cleaning device 22, and it is possible for plasma to be generated in the air bubbles created by the cavitation. In so doing, since the efficiency of the plasma generation is increased, it is possible for the efficiency of the dispersion process to be improved. Accordingly, it is thought that the pulverization processing unit 20 may be any unit which physically pulverizes the dispersoid, and in which cavitation is generated.

As described above, discharging is possible while an arbitrary gas is introduced from the gas introduction pipe connected to the gas storage unit to the plasma generator 38. Examples of the raw material of gas include oxygen (O₂), nitrogen (N₂), air (including at least nitrogen (N₂) and oxygen (O₂)), water vapor (H₂O), nitrous oxide (N₂O), ammonia (NH₃), argon (Ar), helium (He), and neon (Ne). One type of these gases may be independently introduced, or two or more types may be mixed and introduced.

The diameter of the electrodes 32 and 34 is preferably 1 mm or less from the viewpoint of increasing the stability of the in-liquid plasma, and 0.2 mm to 1 mm is more preferable. The distance between the electrodes 32 and (inter-electrode distance) is preferably 0.001 mm to 100 mm from the viewpoint of increasing the stability of the in-liquid plasma, and 0.1 mm to 30 mm is more preferable. The applied voltage is preferably greater than 0 kV and 30 kV or less so that a fixed application is possible, taking stability and depletion and the like of the electrode into consideration, and 1 kV or more and 10 kV or less is more preferable.

It is possible for the dispersoid to be dispersed in the dispersion medium by subjecting the dispersoid in the mixed liquid to the in-liquid plasma processing with the in-liquid plasma processing mechanism 30 while subjecting the dispersoid to the pulverization processing with the pulverization processing mechanism 20 by using the apparatus for producing the dispersion of the first embodiment. According to the production apparatus, because the pulverization processing of the dispersoid and the plasma processing are carried out at approximately the same time in the liquid, the plasma processing can be carried out before the pulverized dispersoid re-aggregates or the like. It is possible for the generation of plasma to be promoted using air bubbles created by cavitation being generated by the pulverization processing mechanism. Thus, efficiency of the dispersion process of the dispersoid in the dispersion medium is improved. Re-aggregation, precipitation and the like of the dispersoid after processing can be prevented over the long term, and a dispersion with excellent dispersion stability can be produced.

### 1.2. Apparatus Configuration of Second Embodiment

FIG. 2 shows a schematic view of an apparatus for producing a dispersion according to the second embodiment. The production apparatus 200 includes a storage tank 110 in which a mixed liquid containing a dispersoid and a dispersion medium is introduced; a pulverization processing mechanism 120 for pulverizing the dispersoid in the mixed liquid introduced in the storage tank 110; and an in-liquid plasma processing mechanism 130 that subjects the dispersoid in the mixed liquid introduced in the storage tank 110 to plasma processing.

In the production apparatus 200 according to the second embodiment, the basic configuration of the storage tank 110 is the same as the production apparatus 100 according to the first embodiment. The basic configuration of the in-liquid plasma processing mechanism 130 is the same as the production apparatus 100 according to the first embodiment, and is provided with the electrode 132, electrode 134, and power source 136.

In the second embodiment, the pulverization processing mechanism 120 is configured by the ultrasound cleaning device 122. The ultrasound homogenizer 122 is configured by an oscillator, a converter, and a horn, not shown. The ultrasound harmonizer 122 is arranged so as to be immersed in the mixed liquid from the opening portion of the storage tank 110. Therefore, the electrodes 132 and 134 in the in-liquid plasma processing mechanism 130 are at a lower position than in the first embodiment. By cavitation being generated by ultrasound in the mixed liquid introduced to the storage tank 110 through the horn, it is possible for the dispersoid to be dispersed in the dispersion medium. The ultrasound homogenizer 122 is thought to have good energy efficiency and good cavitation generation efficiency from the feature of the volume of the ultrasound irradiation target being small compared to the ultrasound cleaning device 22.

It is possible to use an ultrasound homogenizer such as the models “S-250D” or “SLPe40” manufactured by Branson Ultrasonics Corp.

### 1.3. Modification Example

In the second embodiment, although the ultrasound homogenizer 122 is used as the pulverization processing mechanism 120, methods that pulverize the dispersoid while a stirring blade configured in a propeller-shape is rotated, a ball mill, a bead mill, a jet mill, and a nanomizer may be used in place of the ultrasound harmonizer 122. Among these, it is desirable to select a unit in which cavitation is easily generated by the pulverization processing.

### 2. Method of Producing Dispersion

The method of producing a dispersion according to the invention includes preparing a mixed liquid containing a dispersoid and a dispersion medium, and dispersing the dispersoid in the dispersion medium by subjecting the dispersoid in the mixed liquid to an in-liquid plasma processing while subjecting the dispersoid to a pulverization processing. It is possible for the method of producing the dispersion to be easily executed by using the production apparatus according to the first embodiment or the production apparatus according to the second embodiment. Below, each process will be described in detail.

### 2.1. Mixed Liquid Preparation Process

First, a mixed liquid containing the dispersoid and the dispersion medium is prepared. Examples of the dispersion medium include water, an organic solvent, and mixtures of water and a water soluble organic solvent, and are not particularly limited. The surface tension of the dispersion medium may be adjusted by mixing water and a water-soluble organic solvent at arbitrary proportions. The surface tension may be adjusted by adding a surfactant to the dispersion medium. However, according to the method of producing a dispersion according to the embodiment, there is great merit in the features of the dispersoid being able to be finely dispersed even without adding a surfactant or a dispersant, and in being able to produce a favorable dispersion system. Although the surfactant or dispersant reliably contributes to the dispersion stability of the dispersoid, the potential for interfering with the function in cases where the dispersion system is applied to a paint, ink, writing implements, paper, plastic, cloths, building materials, electrical products, electronic materials, medicines, cosmetics, ceramics, and the like is undeniable. Accordingly, it is desirable that a surfactant or dispersant not be added to the dispersion medium.

There are cases where the dissolved oxygen content in the dispersion medium influences the dispersion stability of the dispersoid. As the dissolved oxygen content increases, the donation of the oxygen functional group due to the in-liquid plasma processing more easily occurs, and the dispersion processing efficiency or the dispersion stability further improves. When the dissolved oxygen content in the dispersion medium is high, because it is possible to also use an oxygen-derived plasma source in addition to a water-derived plasma source, hydroxylation of the dispersoid surface proceeds advantageously.

Although the material of the dispersoid is not particularly limited and it is possible to use various particles such as inorganic materials or organic materials according to the application, a solid is preferable. Although fine particles are obtained by the pulverization processing in a case where the dispersoid is a liquid, because the interface of the dispersoid is fluid, it is difficult to obtain an effect in which the interface of the particle is subjected to plasma processing. Meanwhile, in a case where the dispersoid is a solid, since the interface of the dispersoid subjected to the pulverization processing does not have fluidity as in a liquid, the effect due to the plasma processing is easily obtained. Therefore, the efficiency of the dispersion process and the dispersion stability are further improved.

Although the particle size of the dispersoid is not particularly limited, there is a limit on the pulverization processing capacity, such as the above-described ultrasound, and it is difficult to make the particle size finer than the primary particle size. Accordingly, a dispersoid with a large primary particle size from the outset is easily influenced by specific gravity thereby, thus increasing the risk of precipitation or the like, and there is potential for the dispersion stability to be damaged. Therefore, the primary particle size of the dispersoid is preferably less than 1000 nm, and less than 200 nm is more preferable.

It is preferable for the concentration of the dispersoid in the mixed liquid to be 0.1 mass % or more and less than 70 mass %, and 10 mass % or more and 50 mass % or less is more preferable. When the concentration of the dispersoid is 70 mass % or more, the collision frequency of the dispersoid subjected to the pulverization processing rises, and there are cases where re-aggregation and the like of the dispersoid occurs. Such a phenomenon is referred to as “overdispersion” in the specification. Meanwhile, when the concentration of the dispersoid is less than 0.1 mass %, the processing efficiency is lowered because the concentration of the dispersoid is excessively low. Therefore, when the concentration of the dispersoid is in the above range, the dispersion processing efficiency or the dispersion stability further improves.

### 2.2. Process of Pulverization Processing and in-Liquid Plasma Processing

There is no capacity to perform pulverizing of the dispersoid in the in-liquid plasma processing itself. Accordingly, in the in-liquid plasma processing itself, precipitation occurs in cases where the particle size is large. Even if the pulverization processing is carried out, after the dispersoid is subjected to in-liquid plasma processing, since a new interface is formed, surfaces which are not subjected to the plasma processing arise. Meanwhile, in cases where the pulverization processing is performed before the in-liquid plasma processing is performed, aggregation gradually occurs over time, and precipitation occurs due to the enlargement of the particle size.

In light of such reasons, in the present process, the dispersoid is dispersed in the dispersion medium by subjecting the dispersoid in the mixed liquid obtained as above to the in-liquid plasma processing while subjecting the dispersoid to the pulverization processing. In so doing, because the pulverization processing of the dispersoid and the plasma processing are carried out at approximately the same time in the mixed liquid, it is possible to carry out the plasma processing on the active surface of the dispersoid before the pulverized dispersoid re-aggregates or the like. It is possible to use air bubbles created by cavitation being generated by the pulverization processing process, and it is possible for the generation of plasma to be promoted. Thus, efficiency of the dispersion process of the dispersoid in the dispersion medium is improved. Re-aggregation, precipitation and the like of the dispersoid after the dispersoid is dispersed can be prevented over the long term, thereby improving the dispersion stability.

The wording “subjecting (the dispersoid) to the in-liquid plasma processing while subjecting (the dispersoid) to the pulverization processing” is not limited to cases of executing the pulverization processing and the in-liquid plasma processing completely at the same time. The invention includes cases where the two processings are carried out at substantially the same time, and the cases include, for example, (a) to (c) as below.

(a) the pulverization processing and the in-liquid plasma processing start at the same time, and the two processings finish at the same time after being continued for a predetermined time.
(b) the pulverization processing and the in-liquid plasma processing are executed in order or alternately with a short cycle of a given extent.
(c) the pulverization processing is started first, and the in-liquid plasma processing is started from partway through while continuing the pulverization processing, and, after the two processings are continued for a predetermined time, the pulverization processing finishes first, and the in-liquid plasma processing finishes shortly thereafter.

In the process, it is preferable for the volume of the storage tank with respect to one pair of electrodes for in-liquid plasma radiation to be 10 mL or more and less than 100 mL, and 10 mL or more and 50 mL or less is more preferable. When the volume of the storage tank is in the above range, it is possible to prevent the occurrence of heat or overdispersion due to the pulverization processing, and the dispersion processing efficiency and the dispersion stability further improve. The processing capacity can also be improved by using a storage tank provided with a mechanism able to circulate the mixed liquid, a plurality of in-liquid plasma radiation electrodes, and an apparatus capable of subjecting large amounts of a mixed liquid to the pulverization processing.

It is thought that the method of producing a dispersion according to the embodiment is also able to be used when producing a polymer particle dispersion system obtained through emulsion polymerization, a resin dispersion system or the like.

### 3. Dispersion

According to the method of producing a dispersion according to the embodiment, it is possible for the dispersoid to be efficiently dispersed in the dispersion medium, and for the dispersion obtained by the method of production to have excellent dispersion stability. Accordingly, the dispersion obtained by the method of producing a dispersion according to the embodiment is able to be applied to the following materials.

### 3.1. Paint and Ink

The dispersion obtained by the method of producing a dispersion according to the embodiment is able to be applied to paints or inks. In this case, examples of the dispersoid dispersed in the dispersion medium include inorganic pigments, organic pigments, and disperse dyes.

Examples of the inorganic pigments include carbon blacks, such as furnace black, lamp black, acetylene black, and channel black, iron oxide, titanium dioxide, zinc oxide, zirconium oxide, ultramarine blue, Prussian blue, and chromium oxide. These inorganic pigments may be used independently, or two or more types may be used in combination.

Examples of the organic pigment include, azo pigments such as insoluble azo pigments, condensed azo pigments, azo lake, and chelate azo pigments; polycyclic pigments such as phthalocyanine pigments, perylene and perynone pigments, anthraquinone pigments, quinacridone pigments, dioxane pigments, thioindigo pigments, isoindolinone pigments, and quinophthalone pigments; and chelate dyes (for example, a basic dye-type chelate, an acidic dye-type chelate, or the like), lake dyes (for example, a basic dye-type lake, an acid dye-type lake), nitro pigments, nitroso pigments, aniline black, and daylight fluorescent pigments. These organic pigments may be used independently, or two or more types may be used in combination.

Examples of the disperse dye include, for example, C.I. Disperse Yellow 3, 4, 5, 7, 9, 13, 23, 24, 30, 33, 34, 42, 44, 49, 50, 51, 54, 56, 58, 60, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 160, 162, 163, 164, 165, 179, 180, 182, 183, 184, 186, 192, 198, 199, 202, 204, 210, 211, 215, 216, 218, 224, 227, 231, 232; C.I. Disperse Orange 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 61, 66, 71, 73, 76, 78, 80, 89, 90, 91, 93, 96, 97, 119, 127, 130, 139, 142; C.I. Disperse Red 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328; C.I. Disperse Violet 1, 4, 8, 23, 26, 27, 28, 31, 33, 35, 36, 38, 40, 43, 46, 48, 50, 51, 52, 56, 57, 59, 61, 63, 69, 77; C.I. Disperse Green 9; C.I. Disperse Brown 1, 2, 4, 9, 13, 19; C.I. Disperse Blue 3, 7, 9, 14, 16, 19, 20, 26, 27, 35, 43, 44, 54, 55, 56, 58, 60, 62, 64, 71, 72, 73, 75, 79, 81, 82, 83, 87, 91, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333; and C.I. Disperse Black 1, 3, 10, 24. These disperse dyes may be used independently or two or more types may be used in combination.

Examples of the dispersion medium for dispersing the dispersoid include water; lower alcohols such as ethanol, and propanol; cellosolves such as ethylene glycol monomethyl ether, and ethylene glycol mono ethyl ether; carbitols such as diethylene glycol monomethyl ether, and diethylene glycol monoethyl ether; glycol ethers such as ethylene glycol mono-n-butyl ether, diethylene glycol-n-butyl ether, and triethylene glycol-n-butyl ether; polyols such as glycerin, ethylene glycol, diethylene glycol, triethylene glycol, tetraethylene glycol, polyethylene glycol, 1,3-propanediol, 1,4-butanediol, 1,2-hexane diol, 1,5-pentanediol, 1,6-hexane diol, 1,2,6-hexanetriol, and pentaerythritol; lactams such as 2-pyrrolidone, 2-methyl-2-pyrrolidone, and ε-caprolactam; ureas such as urea, thiourea, ethylene urea, and 1,3-dimethyl imidazolidinones; and sugars such as maltitol, sorbitol, gluconolactone, and maltose. These dispersion mediums may be used independently or two or more types may be used in combination.

### 3.2. Light Blocking Paint

The dispersion obtained by the method of producing a dispersion according to the embodiment is able to be applied to a light blocking paint used in electronic components and the like. In this case, examples of the dispersoid dispersed in the dispersion medium include carbon blacks, such as furnace black, lamp black, acetylene black, and channel black, iron oxide, titanium dioxide, zinc oxide, zirconium oxide, and chromium oxide.

The light blocking paint is obtained by the dispersoid being dispersed in an epoxy resin such as a glycidylether-type epoxy resin, a glycidylester-type epoxy resin, a glicidylamine-type epoxy resin, a linear aliphatic epoxide, and an alicyclic epoxide. Accordingly, although the light blocking paint is able to be produced by the method of producing a dispersion according to the embodiment by directly adding the particles to the epoxy resin, also it is possible for a slurry in which the dispersoid is dispersed in the organic solvent to be added to the epoxy resin. It is also possible to use the method of producing a dispersion according to the embodiment when producing the slurry.

Although the organic solvent that is usable when producing the slurry is not particularly limited as long as the compatibility with the epoxy resin is favorable, examples thereof includes known low polar organic solvents such as a hydrocarbon solvent and an aromatic solvent, and known polar solvents such as ether solvent, esters solvents, ketone solvents and amide solvents.

### 3.3 Cosmetics

The dispersion obtained by the method of producing a dispersion according to the embodiment is able to be applied to cosmetics such as cleansing cosmetics, hair cosmetics, basic cosmetics, make up cosmetics, aromatic cosmetics, sunscreen cosmetics, nail cosmetics, eye liner cosmetics, lip cosmetics, and bath cosmetics. In this case, examples of the dispersoid dispersed in the dispersion medium include inorganic powders, such as titanium dioxide, zinc oxide, talc, mica, anhydrous silicic acid, nylon powder, alkyl polyacrylic acid, alumina, and iron oxide.

Examples of the dispersion medium for dispersing the dispersoid include hydrocarbons such as squalane, liquid paraffin, α-olefin oligomers, paraffin wax, ceresin, and microcrystalline wax; animal and plant oils such as corn oil, soybean oil, rapeseed oil, sunflower oil, safflower oil, avocado oil, olive oil, coconut oil, beef tallow, pig oil, and mink oil; synthetic esters such as isopropyl myristate, cetyl octanoate, and cetyl palmitate; natural animal and plant waxes such as jojoba oil, carnauba wax, candelilla wax, japan wax, and beeswax; alcohols such as ethanol, isopropanol, ethylene glycol, glycerin, 1,3-butylene glycol, propylene glycol, and diglycerine; and water.

An additive used in ordinary cosmetics may be included, as appropriate, in the dispersion medium. Examples of such additives include surfactants such as glyceryl stearate, sorbitan stearic acid, polyoxyethylene sorbitan monooleate, polyoxyethylene glyceryl tristearate, polyoxyethylene lauryl ether, triolein decaglyceryl, monolaurate sucrose esters, and polyoxyethylene-hardened castor oil; silicone oils or derivatives thereof such as dimethyl polysiloxane, and methyl phenyl polysiloxane; fluorine-based resins such as perfluoropolyether; water-soluble polymers such as carboxyvinyl polymer, carrageenan, xanthan gum, carboxymethyl cellulose sodium, and sodium hyaluronate; proteins and hydrolyzates thereof such as collagen, elastin, silk, and lactoferrin; ultraviolet absorbers, vitamins, anti-inflammatory agents, amino acids and their derivatives, lecithins, colorings, perfumes, and preservatives.

### 4. Examples

Below, although specific description will be given of the invention based on the examples, the invention is not limited to these examples. The wording “part” and “%” in the examples and comparative examples is based on mass unless otherwise stated.

### 4.1. Apparatus Configuration of Apparatus for Producing Dispersion

The production apparatus A shown in FIG. 1 described in the first embodiment and the production apparatus B shown in FIG. 2 described in the second embodiment are each prepared. The detailed configuration of each production apparatus is as below.

### Production Apparatus a

Pulverization processing mechanism: tabletop ultrasound cleaning device, manufactured by Honda Electronics Co., Ltd., model “W-113” frequency adjustable in three stages of 28 kHz, 45 kHz, and 100 kHz Pulverization processing mechanism: tabletop ultrasound cleaning device, manufactured by Honda Electronics Co., Ltd., model “W-357-07HPD”, frequency: 740 kHz Pulverization processing mechanism: tabletop ultrasound cleaning device, manufactured by Honda Electronics Co., Ltd., model “W-357HPD”, frequency 1000 kHz

In-liquid plasma processing mechanism: electrode material: tungsten, inter-electrode distance: 5 mm, power: 30 V, alternating current frequency: 30 kHz.

### Production Apparatus b

Pulverization processing mechanism: ultrasound homogenizer, manufactured by Branson Ultrasonics Corp., model “S-250D”, frequency: 19.9 kHz, power (energy): 200 W Pulverization processing mechanism: ultrasound homogenizer, manufactured by Branson Ultrasonics Corp., model “SLPe40”, frequency: 40 kHz, power (energy): 150 W In-liquid plasma processing mechanism: electrode material: tungsten, inter-electrode distance: 5 mm, power: 30 W, alternating current frequency: 30 kHz.

### 4.2. Examples 1-17, Comparative Examples 1-2

### Production of Dispersion

Each dispersion was prepared using any of the production apparatuses above, using water as the dispersion medium and using the substances disclosed in Tables 1 to 3 as the dispersoid, and carrying out the in-liquid plasma processing while carrying out the pulverization processing for 10 minutes under the conditions disclosed in Tables 1 to 3.

### Evaluation of Dispersion Stability

After the obtained dispersion was transferred to a sample bottle, the bottle was shaken for 10 seconds while sealed and left to stand at room temperature. After the passage of 24 hours, the state of the dispersion that was left to stand was observed visually. The evaluation criteria are as follows.

“A”: The dispersoid included in the dispersion after being left to stand continues to be substantially evenly dispersed.
“B”: Although a part of the dispersoid included in the dispersion after being left to stand precipitates or is isolated at the liquid surface, the portion is again evenly dispersed by being shaken.
“C”: The dispersoid included in the dispersion after being left to stand precipitates or is completely isolated at the liquid surface, and is not evenly dispersed despite being shaken.

### Measurement of Average Particle Size

The particle size distribution on a volume basis is obtained for the dispersion left to stand for 24 hours as above with a particle size distribution analyzer in which the measurement principle is dynamic light scattering (apparatus name “Nanotrac UPA” manufactured by Nikkiso, Co., Ltd.), and the volume average particle size calculated from the particle size distribution thereof is taken as the average particle size.

### Evaluation Results

The experimental conditions and the evaluation results of the examples 1 to 17 and comparative examples 1 and 2 are shown in tables 1 and 2.

TABLE 1

| | | Example | Example | Example | Example | Example | Example | Example |
|---|---|---|---|---|---|---|---|---|
| | | 1 | 2 | 3 | 4 | 5 | 6 | 7 |
| Pulverization Processing | Apparatus Configuration | b | b | a | a | a | a | a |
| Mechanism | Frequency (kHz) | 20 | 40 | 28 | 45 | 100 | 740 | 1000 |
| Conditions of Mixed Liquid | Dispersoid Type | Carbon 1 | Carbon 1 | Carbon 1 | Carbon 1 | Carbon 1 | Carbon 1 | Carbon 1 |
| | Primary Particle Size (nm) | 17 | 17 | 17 | 17 | 17 | 17 | 17 |
| | Mixed Liquid Volume (mL) | 30 | 30 | 30 | 30 | 30 | 30 | 30 |
| | Dispersoid Concentration | 10 | 10 | 10 | 10 | 10 | 10 | 10 |
| | (mass %) | | | | | | | |
| Evaluation Results | Average Particle Size (nm) | 100 | 200 | 500 | 500 | 500 | 2000 | 3000 |
| | Dispersion Stability | A | A | B | B | B | B | B |

TABLE 2

| | | Example | Example | Example | Example | Example | Example | Example |
|---|---|---|---|---|---|---|---|---|
| | | 8 | 9 | 10 | 11 | 12 | 13 | 14 |
| Pulverization Processing | Apparatus Configuration | b | b | b | b | b | b | b |
| Mechanism | Frequency (kHz) | 20 | 20 | 20 | 20 | 20 | 20 | 20 |
| Conditions of Mixed Liquid | Dispersoid Type | Carbon 1 | Carbon 1 | Carbon 1 | Carbon 2 | Carbon 3 | Carbon 1 | Carbon 1 |
| | Primary Particle Size (nm) | 17 | 17 | 17 | 100 | 3000 | 17 | 17 |
| | Mixed Liquid Volume (mL) | 10 | 50 | 75 | 30 | 30 | 30 | 30 |
| | Dispersoid Concentration | 10 | 10 | 10 | 10 | 10 | 1 | 40 |
| | (mass %) | | | | | | | |
| Evaluation Results | Average Particle Size (nm) | 20 | 200 | 1000 | 500 | 2000 | 20 | 1000 |
| | Dispersion Stability | A | A | B | A | B | A | B |

TABLE 3

| | | Example | Example | Example | Comparative | Comparative |
|---|---|---|---|---|---|---|
| | | 15 | 16 | 17 | Example 1 | Example 2 |
| Pulverization Processing | Apparatus Configuration | b | b | b | b (no ultrasound) | b (no plasma) |
| Mechanism | Frequency (kHz) | 20 | 20 | 20 | — | 20 |
| Conditions of Mixed Liquid | Dispersoid Type | Organic | Inorganic | Inorganic | Carbon 1 | Carbon 1 |
| | | Material | Material 1 | Material 2 | | |
| | Primary Particle Size (nm) | 20 | 600 | 1000 | 17 | 17 |
| | Mixed Liquid Volume (mL) | 30 | 30 | 30 | 30 | 30 |
| | Dispersoid Concentration | 10 | 10 | 10 | 10 | 10 |
| | (mass %) | | | | | |
| Evaluation Results | Average Particle Size (nm) | 200 | 600 | 1000 | 1000 | 200 |
| | Dispersion Stability | A | A | B | C | C |

The type of the dispersoid in Tables 1 to 3 is as follows.

Carbon 1: Trade name “Colour Black S170”, manufactured by Evonik Japan Co., Ltd.
Carbon 2: Trade name “Special Black 101”, manufactured by Orion Engineered Carbons
Carbon 3: Trade name “UF-G5”, manufactured by Showa Denko K.K.
Organic Material: Disperse Red 60, disperse dye
Inorganic material 1: trade name “Talc Nano Ace D-600”, manufactured by Nippon Talc Co., Ltd.
Inorganic material 2: trade name “Talc Nano Ace D-1000”, manufactured by Nippon Talc Co., Ltd.

In Examples 1 and 2, each dispersion was produced by using the apparatus configuration b, and modifying the conditions of the frequency of the ultrasound homogenizer. According to the evaluation results in Examples 1 and 2, all of the dispersions were obtained with favorable dispersion processing efficiency and excellent dispersion stability.

In Examples 3 to 7, each dispersion was produced by using the apparatus configuration a, and modifying the conditions of the frequency of the ultrasound cleaning device. According to the evaluation results of Examples 3 to 7, although all of the dispersions were obtained with favorable dispersion processing efficiency and excellent dispersion stability, because the dispersion processing efficiency is deteriorated compared to a case of using the ultrasound homogenizer (Examples 1 and 2), the average particle size was determined to be large.

In Examples 8 to 10, each dispersion was produced by using the apparatus configuration b and modifying the volume conditions of the mixed liquid. According to the evaluation results of Examples 8 to 10, although all of the dispersions were obtained with favorable dispersion processing efficiency and excellent dispersion stability, it was determined that particularly favorable results were obtained in cases where the volume of the mixed liquid was 10 mL to 50 mL.

In Examples 11 and 12, each dispersion was produced by using the apparatus configuration b, and modifying the type of dispersoid. According to the evaluation results of Examples 11 and 12, although all of the dispersions were obtained with favorable dispersion processing efficiency and excellent dispersion stability, precipitation of the carbon was found in cases of using the carbon 3 in which the primary particle size exceeds 1000 nm, and thus it was determined that a primary particle size of the dispersoid of less than 1000 nm was preferable.

In Examples 13 and 14, each dispersion was produced by using the apparatus configuration b, and modifying the dispersoid concentration conditions. According to the evaluation results of Examples 13 and 14, although all of the dispersions were obtained with favorable dispersion processing efficiency and excellent dispersion stability, it was determined that particularly favorable results were obtained in cases where the dispersoid concentration was 1 mass % to 40 mass %.

In Examples 15 to 17, each dispersion was produced by using the apparatus configuration b, and modifying the type of dispersoid to be an organic material other than carbon or the inorganic materials 1 and 2. According to the evaluation results of Examples 15 to 17, although all of the dispersions were obtained with favorable dispersion processing efficiency and excellent dispersion stability even in cases of using any of the materials, precipitation of the inorganic material 2 was found in cases of using the inorganic material 2 in which the primary particle size was 1000 nm, and thus it was determined that a primary particle size of the dispersoid of less than 1000 nm was preferable.

In Comparative Example 1, only the in-liquid plasma processing was performed without performing the pulverization processing using ultrasound while using the apparatus configuration b, thereby producing the dispersions. According to the evaluation results of the Comparative Example 1, it was determined that the dispersion processing efficiency was low, the average particle size of the dispersoid increased, and the dispersion stability was not excellent due to non-performance of the pulverization processing and non-generation of cavitation.

In Comparative Example 2, only the pulverization processing was performed using ultrasound without performing the in-liquid plasma processing while using the apparatus configuration b, thereby producing the dispersions. According to the evaluation results of Comparative Example 2, although it was possible for the dispersoid to be temporarily finely dispersed, because the in-liquid plasma processing was not performed, it was determined that the average particle size of dispersoid became larger over time, and the dispersion stability was not excellent.

The invention is not limited to the embodiments described above, and various modifications thereof are possible. For example, the invention includes configurations which are substantially the same as the configurations described in the embodiments (for example, configurations having the same function, method and results, or configurations having the same object and effect). The invention includes configurations in which non-essential parts of the configurations described in the embodiments are replaced. The invention includes configurations exhibiting the same operation and effect as the configurations described in the embodiments or configurations capable of achieving the same object. The invention includes configurations in which known techniques were added to the configurations described in the embodiments.

The entire disclosure of Japanese Patent Application Nos. 2014-192137, filed Sep. 22, 2014 and 2015-038290, filed Feb. 27, 2015 are expressly incorporated by reference herein.

What is claimed is:

1. A method of producing a dispersion, comprising:
preparing a mixed liquid containing a dispersoid and a dispersion medium; and
dispersing the dispersoid in the dispersion medium by subjecting the dispersoid in the mixed liquid to an in-liquid plasma processing while subjecting the dispersoid to a pulverization processing.

2. The method of producing a dispersion according to claim 1,
wherein the dispersoid is a solid.

3. The method of producing a dispersion according to claim 1,
wherein the unit that carries out the pulverization processing is a unit that generates cavitation along with the pulverization.

4. The method of producing a dispersion according to claim 1,
wherein the unit that carries out the pulverization processing is an ultrasound generation apparatus, and
the frequency of the ultrasound generating apparatus is 20 kHz or more and 1000 kHz or less.

5. The method of producing a dispersion according to claim 1,
wherein a concentration of the dispersoid in the mixed liquid is 0.1 mass % or more and less than 70 mass %.

6. The method of producing a dispersion according to claim 1,
wherein a primary particle size of the dispersoid is less than 1000 nm.

7. An apparatus for producing a dispersion, comprising:
a storage tank in which a mixed liquid containing a dispersoid and a dispersion medium is introduced;
a pulverization processing mechanism that pulverizes the dispersoid in the mixed liquid introduced in the storage tank; and
an in-liquid plasma processing mechanism that subjects the dispersoid in the mixed liquid introduced in the storage tank to plasma processing,
wherein the dispersoid is dispersed in the dispersion medium by subjecting the dispersoid in the mixed liquid to in-liquid plasma processing with the in-liquid plasma processing mechanism while subjecting the dispersoid to a pulverization processing with the pulverization processing mechanism.
